(19) United States
(12) Patent Application Publication
(10) Pub. No.: US 2024/0403026 A1
(43) Pub. Date: Dec. 5, 2024

(54) OPERATING SYSTEM UPDATE METHOD AND APPARATUS, AND COMPUTER EQUIPMENT

(71) Applicant: Lenovo (Beijing) Limited, Beijing (CN)

(72) Inventors: Zhipeng GAO, Beijing (CN); Ming LEI, Beijing (CN); Zheng SUN, Beijing (CN)

(21) Appl. No.: 18/677,496

(22) Filed: May 29, 2024

(30) Foreign Application Priority Data
Jun. 1, 2023 (CN) 202310640515.7

(51) Int. Cl. G06F 8/65; G06F 9/4401

(52) U.S. Cl. CPC G06F 8/65; G06F 9/4406; G06F 9/4416

(57) ABSTRACT

An operating system update method includes: during a computer equipment power-on startup stage, controlling a system boot processor to interrupt a computer equipment startup process; querying first system version information of a data processing unit (DPU) operating system (OS) in the computer equipment; in response to determining that the first system version information does not match second system version information of a current host OS in the computer equipment, obtaining a system image file of the DPU OS that matches the host OS; controlling DPU to update the DPU OS according to the system image file and restart DPU; and controlling the system boot processor to continue the computer equipment startup process.

### CROSS-REFERENCE TO RELATED APPLICATION

This application claims priority to Chinese Patent Application No. 202310640515.7, filed on Jun. 1, 2023, and the entire content of which is incorporated herein by reference.

### TECHNICAL FIELD

The present disclosure relates to the technical field of computer application technology, and more particularly, to an operating system update method and apparatus, and computer equipment.

### BACKGROUND

In recent years, data processing units (DPUs) have become a third type of important computing chips in data center application scenario following the central processing units (CPUs) and graphics processing units (GPUs), providing computing engines for computing scenarios with high bandwidth, low latency, and intensive data.

Hardware, firmware and operating system (OS) used in computer equipment for DPU application may be sourced from a same provider or may be sourced from different providers. When the hardware, firmware and OS used in the computer equipment for DPU application are from a same provider, developers conveniently and directly transfer part of workload from a host computer to the DPU to reduce the workload of the host computer. When the hardware, firmware and OS used in the computer equipment for DPU application come from different providers, the OS and related functional programs on the DPU are required to coordinate with the OS and related functional programs on the host computer to satisfy data processing need of the computer equipment.

Currently, after successfully starting the OS of the host computer, the OS version of the DPU is detected by the OS of the host computer to determine that the OS version of the DPU does not match the OS version of the host computer. After updating the OS of the DPU, the computer equipment needs to be restarted before performing data processing. The entire process is cumbersome and subject to various limitations.

### SUMMARY

One aspect of the present disclosure provides an operating system update method. The method includes: during a computer equipment power-on startup stage, controlling a system boot processor to interrupt a computer equipment startup process; querying first system version information of a data processing unit (DPU) operating system (OS) in the computer equipment; in response to determining that the first system version information does not match second system version information of a current host OS in the computer equipment, obtaining a system image file of the DPU OS that matches the host OS; controlling DPU to update the DPU OS according to the system image file and restart DPU; and controlling the system boot processor to continue the computer equipment startup process.

Another aspect of the present disclosure provides an operating system update apparatus. The apparatus includes a memory storing a computer program and a processor couple to the memory. When being executed by the processor, the computer program causes the processor to perform: during a computer equipment power-on startup stage, controlling a system boot processor to interrupt a computer equipment startup process; querying first system version information of a data processing unit (DPU) operating system (OS) in the computer equipment; in response to determining that the first system version information does not match second system version information of a current host OS in the computer equipment, obtaining a system image file of the DPU OS that matches the host OS; controlling DPU to update the DPU OS according to the system image file and restart DPU; and controlling the system boot processor to continue the computer equipment startup process.

Another aspect of the present disclosure provides computer equipment. The computer equipment includes a host including an operating system (OS); a data processing unit (DPU) including an OS; and a management controller coupled to the host and the DPU respectively. The management controller is configured to perform: during a computer equipment power-on startup stage, controlling a system boot processor to interrupt a computer equipment startup process; querying first system version information of the DPU OS in the computer equipment; in response to determining that the first system version information does not match second system version information of a current host OS in the computer equipment, obtaining a system image file of the DPU OS that matches the host OS; controlling DPU to update the DPU OS according to the system image file and restart DPU; and controlling the system boot processor to continue the computer equipment startup process.

### BRIEF DESCRIPTION OF THE DRAWINGS

To more clearly describe the technical solutions in the embodiments of the present disclosure or related technologies, the accompanying drawings that need to be referenced in the description of the embodiments or the prior art will be briefly described below. Obviously, the drawings in the following description are merely some embodiments of the present disclosure. Those of ordinary skill in the art may also obtain other drawings based on the provided drawings without creative efforts.

FIG. 1 is a schematic diagram of an exemplary hardware structure of computer equipment suitable for an operating system update method according to some embodiments of the present disclosure;

FIG. 2 is a schematic diagram of another exemplary hardware structure of computer equipment suitable for an operating system update method according to some embodiments of the present disclosure;

FIG. 3 is a flowchart of an exemplary operating system update method according to some embodiments of the present disclosure;

FIG. 4 is a flowchart of another exemplary operating system update method according to some embodiments of the present disclosure;

FIG. 5 is a flowchart of another exemplary operating system update method according to some embodiments of the present disclosure;

FIG. 6 is a structural diagram of an exemplary operating system update apparatus according to some embodiments of the present disclosure; and

FIG. 7 is a structural diagram of another exemplary operating system update apparatus according to some embodiments of the present disclosure.

### DETAILED DESCRIPTION OF THE EMBODIMENTS

As described in the background section, synchronization between an operating system (OS) of a host computer (or host OS) and the OS of a data processing unit (DPU) (or DPU OS) is needed, especially when the host computer and the DPU share a hardware platform. When installing the operating system of the host computer, an installer may also deploy the OS to the DPU through a server baseboard management controller (BMC). However, if a new DPU is installed after the OS of the host computer is deployed, it is usually necessary to run an update program on the DPU or an update service program on the host OS after the computer equipment is successfully powered on and the host OS is running normally. Alternatively, after a mismatch between the host OS version and the DPU OS version may be manually detected, the update program on the DPU is run to update the DPU OS version, and after the DPU OS version is updated, the host computer device is restarted to operate normally.

To simplify a synchronization process between a host OS version and a DPU OS version, the present disclosure provides a synchronization method. The method includes: after the computer equipment is powered on, a startup process (such as a power-on self-test process) is performed. A system boot processor is configured to traverse each peripheral component interconnect express (PCIe, an IO bus) device, such as a unified extensible firmware interface (UEFI) device, to detect whether configuration thereof is correct, and then to guide the host OS to run after passing the test. The present disclosure will not describe details of the power-on self-test process of the computer equipment. Before the startup process is performed, the server BMC detects whether the host OS and the DPU OS match. If a match is detected, the startup process can be executed normally. If no match is detected, the server BMC automatically updates the DPU OS during the startup process. After the DPU OS is restarted, the system boot processor is triggered to start the startup process to detect original PCIe devices of the computer equipment and virtual devices generated by a DPU OS update. Thus, the host computer does not need to be restarted, thereby improving OS update efficiency. The method is suitable for scenarios where a new DPU is installed in the computer equipment. For example, a new DPU needs to be added due to business expansion, or an existing DPU fails and is replaced by a new DPU. Various application scenarios are not restricted by the present disclosure.

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without creative efforts fall within the scope of the present disclosure.

FIG. 1 is a schematic diagram of an exemplary hardware structure of computer equipment suitable for an operating system update method according to some embodiments of the present disclosure. The computer equipment may be a server. As shown in FIG. 1, the computer equipment includes a host 11, a data processing unit (DPU) 12, and a management controller 13 connected to the host 11 and DPU 12 respectively. Both the host 11 and DPU 12 have their own operating systems. The two operating systems need to match before the computer equipment can operate normally. The present disclosure does not elaborate on the respective composition structures and operation principles of the host 11 and DPU 12.

The management controller 13 may be a BMC, and it may be physically connected to DPU through a PCIe bus and/or a reduced media independent interface (RMII) signal line. Because the DPU is a PCIe device, BMC may connect to the PCIe bus through a PCIe interface to connect to DPU connected to the PCIe bus.

In some embodiments, an operator may log in to a server BMC platform through a web page, output a BMC management interface, send a self-test interrupt signal to the system boot processor of the computer equipment, and trigger the system boot processor to interrupt the computer equipment startup process. The method is described below to achieve synchronous updates of the DPU OS and the host OS.

In practical applications, a motherboard of the computer equipment is usually equipped with an RMII signal line, which connects to network equipment with RMII. Therefore, if DPU is equipped with an external RMII interface, a private network connection may be established between DPU and BMC through the RMII signal line. As such, communication based on hyper text transfer protocol (HTTP) and network controller sideband interface (NCSI) protocols is established. The present disclosure does not limit communication methods between DPU and BMC, which is determined based on actual situation.

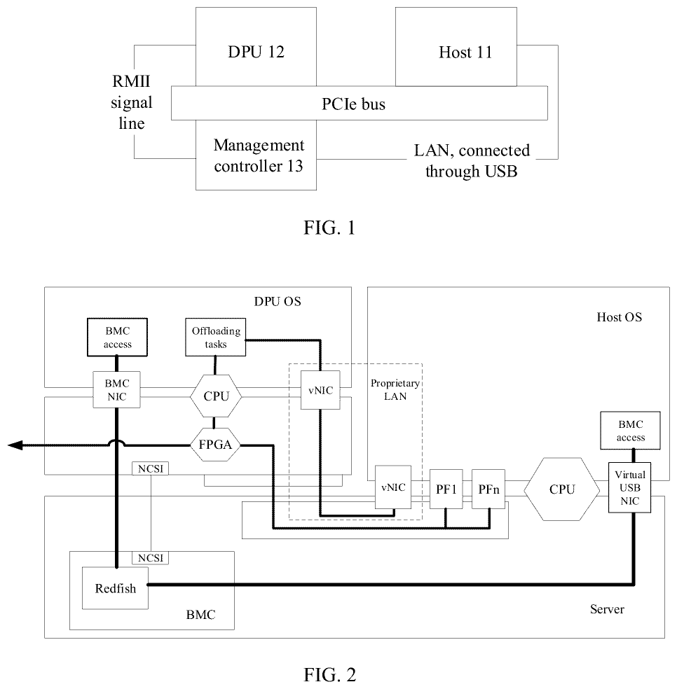

FIG. 2 is a schematic diagram of another exemplary hardware structure of computer equipment suitable for an operating system update method according to some embodiments of the present disclosure. NCSI interfaces may be configured in both DPU and BMC to implement NCSI communication. To implement the operating system update method provided in the present disclosure, the BMC may also be connected to DPU through Redfish (a management standard based on HTTPs services). As shown in FIG. 2, the DPU OS may facilitate BMC access through a network interface card (NIC). An implementation process thereof will not be described in detail herein.

DPU is a special processor that is different from a central processing unit (CPU) and a graphics processor (GPU), and is often used in data center scenarios. DPU provides a computing engine for high-bandwidth, low-latency, and data-intensive computing scenarios to improve data processing speed. DPU may be used as an offloading engine for the CPU, releasing computing power of the CPU to upper-layer applications and accelerating overall performance of the computer equipment.

In practical applications, a field programmable gate array (FPGA) network card may be constructed to improve the data processing speed. For example, by interacting with CPU data of the computer equipment, DPU may be used as an offloading engine of the CPU to perform corresponding offloading tasks, and also to communicate with the host OS through different ports of the PCIe bus to achieve synchronization between the DPU OS and the host OS. The present disclosure does not limit on composition structure and operation principle of the DPU.

In addition, a local area network (LAN) exists between the management controller 13 and the host 11. As shown in FIG. 2, a virtualized network interface controller (vNIC) may be created to make the DPU OS and the host OS communicate with the BMC through a communication connection between vNIC and the PCIe bus. Further, BMC's Redfish may also connect to the host OS through a virtual USB (vUSB) network card. However, the communication connection method is not limited to the above description. The present disclosure does not limit the communication method between the various components of the computer equipment.

It should be understood that the structure of the computer equipment shown in FIG. 1 and FIG. 2 does not constitute a limitation on the computer equipment in the embodiments of the present disclosure. For convenience of description, only parts related to the relevant embodiments of the present disclosure are shown in the drawings. Under circumstances of no conflict, the embodiments and features in the embodiments of the present disclosure may be combined with each other. Therefore, in actual applications, the computer equipment may include more or fewer components than those shown in FIG. 1 and FIG. 2, or may combine certain components, which are not listed herein.

Combined with the computer equipment described above, the operating system update method proposed by the present disclosure will be described below from the aspect of the management controller (taking BMC as an example). However, it is not limited to processes described below, and each step in the processes may not be executed exactly in the order described in the following embodiments. Steps may be processed in reverse order or simultaneously according to actual needs. Other operations may also be added to these processes, or a certain step or multiple steps may be removed from these processes. The present disclosure does not provide detailed examples.

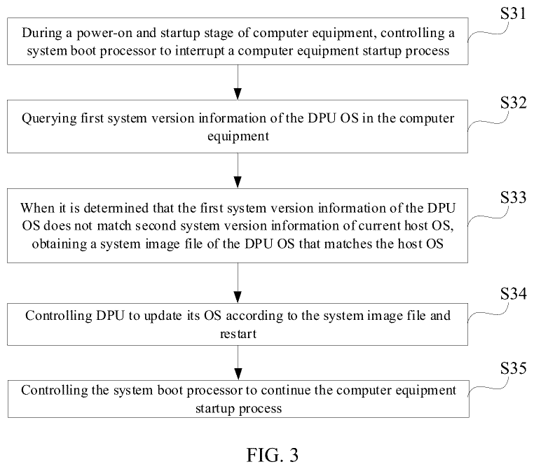

FIG. 3 is a flowchart of an exemplary operating system update method according to some embodiments of the present disclosure. As shown in FIG. 3, the operating system update method may include the following processes.

At S31, during a power-on and startup stage of computer equipment, a system boot processor is controlled to trigger an interrupt to a computer equipment startup process.

In practical applications, during the system power-on and startup process of the computer equipment, the system boot processor (UEFI) usually first traverses PCIe devices for self-test startup operation, and guides the host OS to run. Considering relevant description of the embodiments of the present disclosure, the match between the host OS version and the DPU OS version needs to verified before the host OS run normally. Therefore, during the system power-on process, the system boot processor may wait for a signal sent by the management controller (e.g., BMC) indicating that the traversal can start before traversing the PCIe devices. If the system boot processor does not receive the signal sent by the BMC, the system boot processor may be triggered to interrupt the computer equipment startup process, which may be achieved through but is not limited to outputting an interrupt signal.

As analyzed above, for the computer equipment startup process, the system boot processor may first traverse the PCIe devices, and perform inspection (e.g., status, security, etc., depending on actual situations) on the PCIe devices and other devices (including hardware, firmware, loaded applications, virtual devices, etc.) After the inspection is passed, the host operation may proceed as guided by a boot program. The present disclosure does not limit startup process content of the computer equipment itself, which depends on actual situations.

At S32, first system version information of the DPU OS in the computer equipment is queried.

At S33, when it is determined that the first system version information of the DPU OS does not match second system version information of current host OS of the computer equipment, a system image file of the DPU OS that matches the host OS is obtained.

In the embodiments of the present disclosure, before executing the startup process of the computer equipment, BMC may first query whether the host OS version and the DPU OS version of the computer equipment match, such that the version of the host OS running after the computer equipment is started matches the version of the DPU OS to ensure normal operation of the computer equipment. As such, BMC may directly query version information of the OS currently configured on the DPU and record it as the first system version information, may determine version information of the host OS currently configured on the computer equipment and record it as the second system version information, and may, through comparison, determine whether the version of the host OS currently configured on the computer equipment matches the version of the OS on the DPU.

Regarding the version information of the host OS, an installation program (which may be an original installation program or an upgrade program) may send the installed host OS and the version information thereof to BMC for storage during a process of installing the host OS (which may be an initial installation or an installation after upgrading the original version). As shown in the structural example described above, information may be transmitted according to the communication connection method between the host and BMC. The present disclosure does not limit transmission method for the host OS and its version information.

When the OS on the DPU is configured for the first time in the computer equipment, as analyzed above, the installation program may determine the version information of a matching DPU OS through a server BMC when installing the host operating system, and may obtain the corresponding DPU OS (e.g., downloading from a supplier application platform) and deploy it on the DPU. Data processing (e.g., acceleration or offloading, etc.) may be performed through collaboration between the DPU OS and its related programs and the host OS and its related programs.

During the above execution process, a CPU of the computer equipment may execute an installation program or an upgrade program to record a download address of the second system version information, the version information of the DPU OS that matches the second system version information, and the system image file of the DPU OS, as the OS image address. The OS image address is sent to the server BMC through an existing physical channel (e.g., the LAN channel or virtualized USB network interface, etc.) such that BMC can download the DPU system image file according to the system image address, can also store the DPU system image file in a memory of BMC, or can send the DPU system image file to an external memory connected to BMC. Implementation process of deploying the DPU OS will not be elaborated herein.

To facilitate subsequent use of the DPU system image file and achieve synchronization between the DPU OS and the host OS, such as update synchronization in scenarios such as an old version of the operating system being configured in a newly installed DPU (i.e., an OS that does not match the host OS), BMC may store the DPU system image file obtained during the installation process and matching the host OS or the download address thereof (i.e., system image address). Alternatively, BMC may also send the system image file to an external memory for storage, and determine its storage address to be the system image address of the DPU system image file that matches the host OS.

In the scenario of DPU update of the computer equipment, after installing a new DPU in the computer equipment, there is no guarantee that its configured OS and its related programs match the host OS and its related programs. During the system power-on and startup process of the computer equipment, according to the above-described method, the power-on self-test (e.g., computer equipment startup process) stops before the DPU OS is ready. When the DPU OS is not ready or its version does not match the host OS version, BMC may force DPU to enter http boot from the previously stored DPU OS image, that is, obtain the previously stored system image file of the DPU OS that matches the host OS.

At S34, DPU is controlled to update its OS according to the system image file and restart DPU.

At S35, the system boot processor is controlled to continue the computer equipment startup process.

Further, after BMC prepares the DPU system image file that matches the first system version information of the host OS according to the method described above, BMC may notify DPU to install and boot the system image file. For example, the service program is booted through HTTP. Required programs are obtained from the system image file to update the DPU OS. After confirming that the DPU OS update is completed, DPU is restarted without restarting the entire system of the computer equipment, thereby reducing time spent on restarting.

Then, the first system version information of the current DPU OS is rechecked according to the method described above to see if the first system version information matches the second system version information of the host OS. After a match is determined, BMC notifies the system boot processor to continue executing the computer equipment startup process. As such, the system boot processor can not only traverse the original PCIe devices of the computer equipment, but also traverse the virtual devices as a result of updating the DPU OS to realize self-test of various devices. After confirming that the inspection passes, DPU OS is guided to run successfully.

After restarting DPU, because the currently installed OS matches the version of the host OS, BMC may also directly notify the system boot processor to continue the computer equipment startup process, that is, the system POST process. After confirming that the self-test passes, the DPU OS is guided to run normally and the computer equipment is successfully powered on. Thus, the DPU OS and its related programs coordinate with the host OS and its related programs to perform the data processing function.

It can be seen that in the case where the version information of the host OS of the computer equipment and the DPU OS do not match, the present disclosure provides a method of synchronization between the host OS and the DPU OS during the initial system startup process of the computer equipment. Specifically, value-added functions of BMC improve data processing capabilities through inspecting firmware behaviors of the server during the system POST process. That is, during the power-on startup process, the system boot processor is triggered to interrupt the startup process. BMC first queries the host OS of the computer equipment and the DPU OS to determine whether the version information matches. If not, the system image file of the DPU that matches the version of the host OS is obtained. For example, the operating system file of DPU that matches the version information of the host OS is installed. DPU is directly notified accordingly to update its own operating system such that the DPU OS matches the host OS. At this time, only DPU needs to restart without restarting the entire system. The system boot processor is triggered directly to continue the startup process. As such, during the startup process of the computer equipment, the synchronization between the host OS and the DPU OS can be achieved.

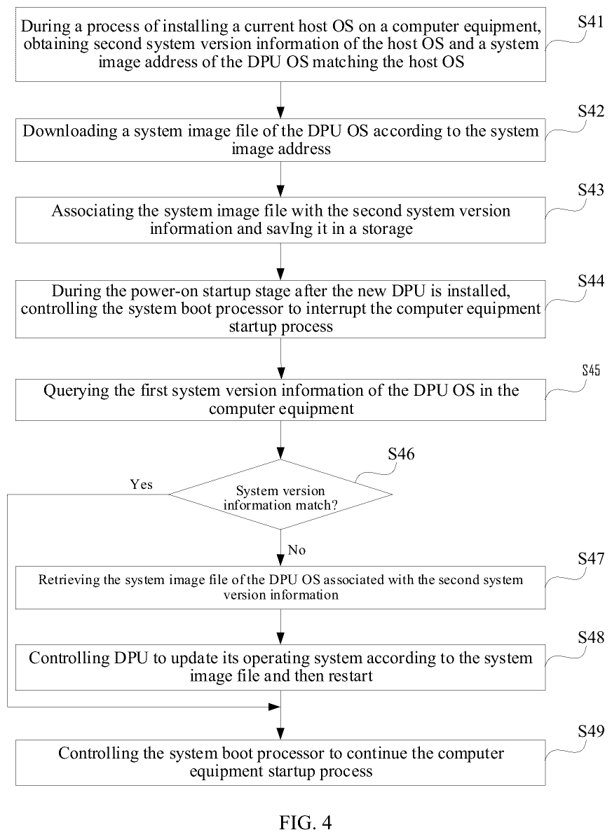

FIG. 4 is a flowchart of another exemplary operating system update method according to some embodiments of the present disclosure. The operating system update method will be described from a server BMC perspective. That is, the host OS is automatically synchronized to the DPU OS. As shown in FIG. 4, the method may include the following processes.

At S41, during a process of installing a current host OS on a computer equipment, second system version information of the host OS and a system image address of the DPU OS matching the host OS are obtained.

At S42, a system image file of the DPU OS is downloaded according to the system image address.

At S43, the system image file is associated with the second system version information and is saved in a storage.

Considering the above description of the process of installing the host OS on the computer equipment, a matching DPU OS is configured through a server BMC. That is, when DPU is installed for the first time on the computer equipment, the DPU OS matches the host OS. BMC downloads the DPU OS that matches the version information of the installed host OS. The corresponding download address in the application platform that provides the DPU OS can be recorded as the system image address. The installation program of the host OS sends the system image address to BMC, such that BMC can download the DPU OS that matches the host OS and deploy the DPU OS on DPU. The implementation process will not be described in detail herein.

To facilitate subsequent retrieval of the DPU OS that matches the host OS directly from BMC, BMC may perform an image process on the downloaded DPU OS to obtain a DPU system image file that matches the host OS, associate it with the version information of the host OS, and save it in a storage, such that the system image file of the DPU OS that matches the host OS can be quickly queried based on the version information of the host OS. In some embodiments, BMC may also send the system image file to an external device (such as an external memory) for storage, and record the access address of the system image file, such that BMC can subsequently retrieve the system image file of the DPU OS that matches the host OS from the external device based on the access address.

In some embodiments, during the installation process of the host OS, at the same time when the installation program sends the second system version information of the host OS to the server BMC, the installation program may also record the address for downloading the DPU OS that matches the host OS as the system image address and send it to BMC, such that BMC can deploy the DPU OS for the first time. At the same time, BMC may store the system image address such that BMC can directly download the DPU OS (i.e., the DPU system image file) that matches the host OS according to the system image address.

At S44, during the power-on startup stage after the new DPU is installed on the computer equipment, the system boot processor is controlled to trigger an interrupt to the computer equipment startup process.

Further, in the scenario where a new DPU is installed on the computer equipment, it is impossible to determine whether the OS in the new DPU matches the current host OS. The operating system update method provided by the present disclosure may be performed during the power-on self-test (POST) process. The system boot processor (such as system UEFI) is triggered to interrupt the startup process and perform subsequent processes.

At S45, the first system version information of the DPU OS in the computer equipment is queried.

At S46, a match between the first system version information and the second system version information is determined. If no match is determined, S47 is executed. If a match is determined, S49 is executed.

As analyzed above, when the computer equipment installs the current host OS, BMC obtains the second system version information of the installed host OS. After a new DPU is installed in the computer equipment, BMC directly queries the version information of the OS in the new DPU, and record the version information of the DPU OS as the first system version information. Whether the OS in the current DPU matches the host OS is determined by comparing the first system version information with the second system version information. For example, whether two system version information are consistent is determined. If a match is determined, the OS on the new DPU does not need to be updated, and BMC notifies the system boot processor to continue the startup process.

At S47, the system image file of the DPU OS associated with the second system version information is retrieved.

According to the above method, when it is determined that the DPU OS currently installed on the computer equipment does not match the host OS, the system image file of the DPU OS that matches the host OS may be obtained during the power-on and startup process. As analyzed above, BMC may directly retrieve the associated DPU system image file from the storage according to the second system version information of the host OS, that is, the OS deployed by the original DPU that matches the host OS.

In some embodiments, as analyzed above, after BMC obtains the DPU system image file, BMC directly sends the DPU system image file to an external device for storage. After recording the access address of the system image file in the external device, BMC may use the access address to retrieve the system image file from the external device. Of course, during the process of BMC deploying the OS matching the host OS in the original DPU, its system image file is not stored in BMC or in the external device. BMC records the system image address for downloading the system image file of the DPU OS matching the host OS reported by the installation program during the installation process of the host OS. As such, when the computer equipment is powered on for the first time after installing a new DPU, the system image address may be used to download the system image file of the DPU OS matching the host OS, that is, the system image file of the original DPU OS. The present disclosure does not limit the method of obtaining the system image file.

At S48, DPU is controlled to update its operating system according to the system image file and then restart.

At S49, the system boot processor is controlled to continue the computer equipment startup process.

Regarding the implementation process of S48 and S49, reference can be made to the description of the corresponding parts of the embodiments described above, and detail description thereof will be omitted herein.

In the embodiments of the present disclosure, during the process of installing (including upgrading and installing) the host OS on the computer equipment, the DPU OS is usually deployed through the server BMC, such as installing a second version of the installed host OS through the installation program. The system version information and the download address of the system image file of the matching DPU OS, that is, the corresponding system image address on the developer's application platform, are sent to BMC. As such, during the power-on startup process after the first time the computer equipment is powered on after installing a new DPU, before executing the startup process, that is, before booting the host OS to successfully start running, BMC may automatically determine whether the first system version information of the new DPU OS and the second system version information of the host OS currently installed on the computer equipment match. If no match is determined, because the OS deployed on the original DPU matches the host OS, the stored system image file of the original DPU OS can be directly retrieved, or the system image file of the original DPU OS can be retrieved directly, or the system image file of the original DPU OS can be retrieved directly according to the retrieval method for retrieving the original DPU OS. The OS of the new DPU is updated accordingly. Restarting DPU ensures that the OS on DPU matches the host OS. At the same time, the host OS of the computer equipment does not need to restart. The system boot processor is controlled directly to continue to execute the automatic startup process. Thus, efficiency of automatic synchronization between the DPU OS and the host OS is improved.

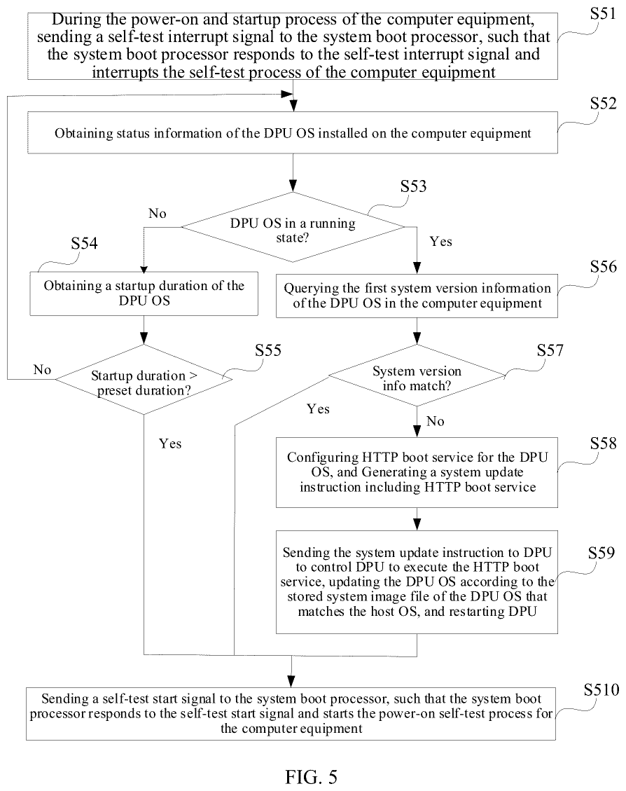

FIG. 5 is a flowchart of another exemplary operating system update method according to some embodiments of the present disclosure. The operating system update method will continue to be described from the server BMC perspective. The computer equipment is installed or upgraded to the host OS, for example, in the scenario where a new DPU is installed due to the failure of the original DPU or other reasons. As shown in FIG. 5, the method may include the following processes.

At S51, during the power-on and startup process of the computer equipment, a self-test interrupt signal is sent to the system boot processor, such that the system boot processor responds to the self-test interrupt signal and interrupts the self-test process of the computer equipment.

In some embodiments, during the first power-on startup process after a new DPU is installed on the computer equipment, to ensure that the DPU OS matches the host OS, BMC first triggers the system boot processor to interrupt the startup process, for example, by sending the self-test interrupt signal to the system boot processor to notify the system boot processor to interrupt starting the POST process. When powering on and starting, before traversing each PCIe device in the computer equipment, the system boot processor waits for BMC to send a release signal, start the POST process, and start traversing PCIe devices.

At S52, status information of the DPU OS installed on the computer equipment is obtained.

At S53, based on the status information, whether the DPU OS is in a running state is determined. If the DPU OS is not in the running state, S54 is executed. If the DPU OS is in the running state, S56 is executed.

In practical applications, before BMC detects whether the OS of the newly installed DPU of the computer equipment matches the host OS, BMC may first query whether the DPU in the computer equipment is in the running state. Specifically, BMC may use a communication protocol, such as NCSI or Redifish, which may be determined based on the communication method between BMC and the DPU OS. Therefore, BMC obtains the status information indicating an actual execution stage of the DPU, such as different execution stages represented by different status identifiers. As such, BMC may determine whether the DPU is in the running state through the actual queried status information, thereby determining whether the DPU is in the running state, and whether the OS is ready.

At S54, a startup duration of the DPU OS is obtained.

At S55, whether the startup duration is greater than a preset duration is determined. If the startup duration is not greater than the preset duration, S52 is executed to continue obtaining the status information of the DPU OS. If the startup duration is greater than the preset duration, S510 is executed.

Further, if the DPU OS of the computer equipment does not enter the running state at this time, BMC may wait for the DPU OS to continue running within the preset duration. Therefore, BMC may start the self-test process of the computer equipment from the interruption, count the startup duration of the DPU OS, and determine whether the obtained startup duration is greater than the preset duration, that is, whether the wait is timed out. If the obtained startup duration is not greater than the preset duration, BMC continues to query the status information of the DPU OS according to the above method, and DPU OS enters the running state within the preset duration and performs subsequent operations. If the DPU OS does not enter the running state within the preset duration, query and automatic update process of the DPU OS provided in the present disclosure ends, the system boot processor is triggered to continue the startup process.

In some embodiments, after the startup duration of the DPU OS is timed out according to the above method, subsequent query process may also be directly executed. The present disclosure does not limit a value of the preset duration. The preset duration may be flexibly configured according to actual needs.

In some embodiments, after it is determined that the DPU OS has entered the running state, version check prompt information for the DPU OS may be outputted, for example, whether to turn on a synchronization check of the DPU OS, etc. The present disclosure does not limit content of the version check prompt information and its output method, which may depend on actual situations. Then, an operator may make a selection based on the actual situations. If the operator chooses to turn it on, BMC may obtain a confirmation check instruction for the version check prompt information, and S56 is executed. If the operator chooses not to turn it on, BMC may obtain an exit check instruction for the version check prompt information. The system boot processor is triggered to continue the computer equipment startup process, that is, S510 is executed.

In some embodiments, after BMC determines that the DPU OS has entered the running state, BMC may automatically start the synchronization check of the DPU OS by default and directly execute S56, without operator participation, to automatically achieve synchronization between the DPU OS and the host OS.

At S56, the first system version information of the DPU OS in the computer equipment is queried.

At S57, whether the first system version information matches the second system version information of the host OS is determined. If no match is determined, S58 is executed. If a match is determined, S510 is executed.

Regarding the implementation process of BMC determining whether the version information of the DPU OS currently installed on the computer equipment matches the version information of the host OS, reference can be made to the corresponding description, and detail description will be omitted herein.

At S58, hypertext transfer protocol (HTTP) boot service is configured for the DPU OS, and a system update instruction including HTTP boot service is generated.

At S59, the system update instruction is sent to DPU to control DPU to execute the HTTP boot service, the DPU OS is updated according to the stored system image file of the DPU OS that matches the host OS, and then DPU is restarted.

In actual applications, when BMC determines that the version information of the host OS and the DPU OS in the computer equipment does not match, BMC may first determine whether DPU has been forced to start in an HTTP boot mode, that is, determine whether DPU has performed the HTTP boot service. If so, it means that DPU has been forced to run according to the currently deployed OS, and S510 may be directly executed to start the startup process of the computer equipment. On the contrary, BMC may configure the HTTP boot service to obtain the system image file of the DPU OS that matches the host OS, and force DPU to update the currently deployed DPU OS based on the system image file of the DPU OS stored by BMC.

As such, BMC may include and send the system update instruction of the HTTP boot service to DPU, that is, sending an instruction to force the HTTP boot service to DPU such that DPU can execute the HTTP boot service and update its OS with what BMC has prepared, that is, the system image file of the DPU OS that matches the host OS. In other words, DPU is forced to enter the HTTP boot service from a previously saved DPU OS image, and DPU is guided to update the system image file. For example, DPU performs the update process, downloads the corresponding system image file from BMC, and updates the corresponding OS content until the entire OS is updated. The present disclosure does not limit the implementation process of how DPU implements the OS update through the HTTP boot service.

During the update process of the DPU OS, DPU may record an update and installation progress of the DPU system image file prepared by BMC, which can be determined based on a ratio between the updated content and the entire DPU system image file to be updated. BMC may poll the update and installation progress on the DPU OS to determine whether the synchronization update of the DPU OS and the host OS has been completed within a preset update time. If the synchronization update is completed within the preset update time, BMC may restart DPU. Otherwise, the synchronization update is not completed. BMC may continue to query the update and installation progress of the DPU OS until the synchronization update of the DPU OS is completed.

In some embodiments, the above process of querying the update and installation progress of the DPU OS may be used to determine whether the synchronization update of the DPU OS has been completed. After it is determined to be completed, DPU is restarted. Otherwise, BMC continues to wait for the synchronization update of the DPU OS without setting a default update duration. Similarly, whether the DPU OS enters the running state can also be determined in this way, and then subsequent query of the synchronization update of the DPU OS may be performed.

After DPU is restarted, S52 is executed. Whether the current DPU OS matches the host OS may be determined according to the process described above. If no match is determined, it means that an error may occur in the last synchronization update process of the DPU OS. The process described above may be used to re-update the DPU OS. If a match is determined, S510 is executed, such that the synchronization update of the DPU OS and the host OS can be completed at the first power-on after the new DPU is installed on the computer equipment, without restarting the host OS to perform the power-on self-test process.

At S510, a self-test start signal is sent to the system boot processor, such that the system boot processor responds to the self-test start signal and starts the power-on self-test process for the computer equipment.

Regarding the startup process of the computer equipment at S510, reference can be made to but is not limited to the traversal of hardware devices such as PCIe devices and operational virtual devices described above. Various aspects such as normality and security of each operational device may be verified. After passing the verification, the host OS is guided to enter the running state, that is, the computer equipment is successfully started. The DPU OS and its related programs may now operate together with the host OS and its related programs to achieve acceleration or offloading of OS tasks. The present disclosure does not limit the implementation methods of data processing functions.

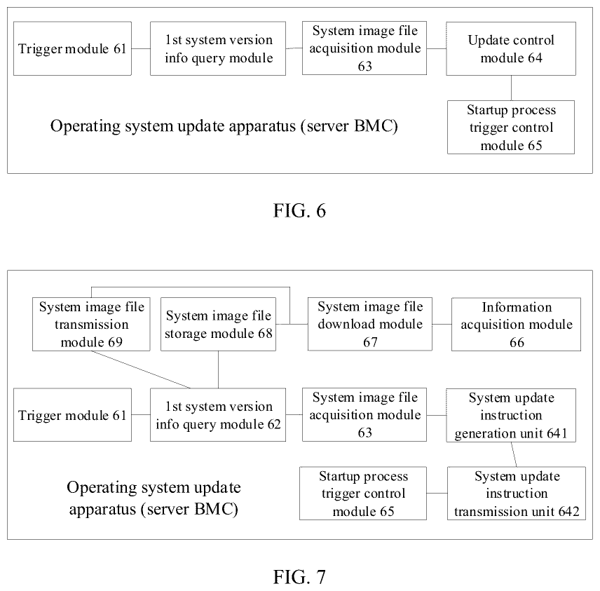

FIG. 6 is a structural diagram of an exemplary operating system update apparatus according to some embodiments of the present disclosure. The apparatus may be applied to a server BMC and may be used to achieve automatic synchronization between a DPU OS and a host OS in a scenario where a new DPU is installed on a computer equipment. As shown in FIG. 6, the operating system update apparatus may include a trigger module 61 configured to control and trigger a system boot processor to interrupt a computer equipment startup process during a power-on and startup process of the computer equipment; a first system version information query module 62 configured to query first system version information of the DPU OS in the computer equipment; a system image file acquisition module 63 configured to obtain a system image file of the DPU OS that matches the host OS when it is determined that the first system version information does not match second system version information of the host OS; an update control module 64 configured to control DPU to update its OS according to the system image file and restart DPU; and a startup process trigger control module 65 configured to control and trigger the system boot processor to continue the computer equipment startup process.

FIG. 7 is a structural diagram of another exemplary operating system update apparatus according to some embodiments of the present disclosure. In some embodiments, as shown in FIG. 7, the apparatus may also include an information acquisition module 66 configured to obtain the second system version information of the host OS and a system image address of a system image file of the DPU OS that matches the host OS during an installation process of a current host OS on the computer equipment; a system image file download module 67 configured to download the system image file of the DPU OS according to the system image address; a system image file storage module 68 configured to store the system image file associated with the second system version information; or a system image file transmission module 69 configured to send the system image file to an external device for storage, and record an access address of the system image file.

Further, the system image file acquisition module 63 may include: a first determination unit configured to determine the system image file of the DPU OS stored in association with the second system version information; or a first retrieval unit configured to retrieve the system image file of the DPU OS from the external device according to the access address.

In some embodiments, as shown in FIG. 7, the update control module 64 may include: a system update instruction generation unit 641 configured to configure a HTTP boot service for the DPU OS and generate a system update instruction including the HTTP boot service; and a system update instruction transmission unit 642 configured to send the system update instruction to DPU to control DPU to execute the HTTP boot service and update the DPU OS according to the system image file.

In some embodiments, the operating system update apparatus may further include: a status information acquisition unit configured to obtain status information of the DPU OS; and a running state determination unit configured to determine whether the DPU OS is in a running state based on the status information, and trigger the first system version information query module 62 to query the first system version information of the DPU OS in the computer equipment.

In some embodiments, the operating system update apparatus may further include: a version check prompt information output module configured to output version check prompt information for the DPU OS when the running state determination unit determines that the DPU OS is in the running state; a confirmation check instruction acquisition module configured to obtain a confirmation check instruction for the version check prompt information, and trigger the first system version information query module 62 to query the first system version information of the DPU OS in the computer equipment; an exit check instruction acquisition module configured to obtain an exit check instruction for the version check prompt information, and trigger the system boot processor to continue the computer equipment startup process.

In some embodiments, the operating system update apparatus may further include: a startup duration acquisition module configured to determine, based on the status information, whether the DPU OS has entered the running state, and obtain a startup duration of the DPU OS; and a startup triggering module configured to determine whether the startup duration is longer than a preset duration, and trigger the system boot processor to continue the computer equipment startup process.

In some embodiments, the trigger module 61 may include: a self-test interrupt signal transmission unit configured to send a self-test interrupt signal to the system boot processor, such that the system boot processor responds to the self-test interrupt signal and interrupts the starting of the self-test process of the computer equipment.

Correspondingly, both the startup process trigger control module 65 and the trigger module 61 may include: a self-test startup signal transmission unit configured to send a self-test startup signal to the system boot processor, such that the system boot processor responds to the self-test startup signal and starts the self-test process of the computer equipment.

In some embodiments, the operating system update apparatus may trigger the trigger module 61 to control and trigger the system boot processor to continue the computer equipment startup process when it is determined that the first system version information matches the second system version information.

The operating system update apparatus may further include a determination module configured to determine whether DPU has executed the HTTP boot service when it is determined that the first system version information does not match the second system version information of the current host OS of the computer equipment. If it is determined that DPU has executed the HTTP boot service, the trigger module is triggered to control the system boot processor to continue the computer equipment startup process. If it is determined that DPU has not executed the HTTP boot service, the system image file acquisition module 63 is triggered to obtain the system image file of the DPU OS that matches the host OS.

Further, in a scenario such as business expansion, the computer equipment needs to add a new DPU, or the original DPU fails and a new DPU replaces the failed DPU, causing the installed DPU OS and the host OS to be out of sync, BMC may automatically update the DPU OS during the power-on and self-test process without the need to restart the host OS. Thus, the efficiency of the synchronization update of the DPU OS is improved.

It should be noted that the various modules, units, etc. in the apparatus embodiments may be stored in memories as program modules, and a processor executes the program modules stored in the memories to implement corresponding functions. For the functions implemented by each program module and its combination, as well as the technical effects achieved, reference can be made to the description of the corresponding parts of the method embodiments, and detail description thereof will be omitted herein.

The present disclosure also provides a computer-readable storage medium, on which a computer program can be stored. The computer program can be called and loaded by a management controller (such as BMC) to implement various processes of the operating system update method described in the embodiments of the present disclosure. For implementation details, reference can be made to the description of corresponding parts of the above-described embodiments.

It should be noted that in the above embodiments, unless the context clearly indicates exceptions, words such as “a”, “an”, and/or “the” do not specifically refer to the singular and may also include the plural. Generally speaking, the terms “including” and “comprising” only imply the inclusion of clearly identified processes and elements, and these processes and elements do not constitute an exclusive list. The method or apparatus may also include other processes or elements. An element qualified by the statement “comprises a . . . ” does not exclude the presence of other identical elements in the process, method, product or device that includes the element.

In the description of the embodiments of the present disclosure, unless otherwise stated, “/” means or, for example, A/B can mean A or B; “and/or” in this specification is only a way to describe association relationships between related objects, meaning there may be three relationships. For example, A and/or B may mean: A alone exists, A and B exist simultaneously, and B alone exists. In addition, in the description of the embodiments of the present disclosure, “plurality” refers to two or more than two.

Terms such as “first”, “second”, etc. used in the present disclosure are merely for descriptive purposes and are used to distinguish one operation, unit or module from another operation, unit or module, and do not necessarily require or imply such actual relationship or sequence between these units, operations or modules. And it should not be understood as indicating or implying the relative importance or implicitly indicating the number of indicated technical features. Therefore, the features defined as “first” and “second” may expressly or implicitly include one or more such feature.

In addition, each embodiment in this specification is described in a progressive or parallel manner. Each embodiment focuses on its differences from other embodiments. The same and similar parts between various embodiments can be referred to each other. As for the devices and computer equipment disclosed in the embodiments, because they correspond to the methods disclosed in the embodiments, the description is relatively simple. For relevant details, reference can be made to the description in the method embodiments.

The description of the disclosed embodiments enables those skilled in the art to implement or use the present disclosure. Various modifications to these embodiments will be readily apparent to those skilled in the art, and the generic principles defined herein may be practiced in other embodiments without departing from the spirit or scope of the present disclosure. Thus, the present disclosure is not intended to be limited to the embodiments shown herein but is to be accorded the broadest scope consistent with the principles and inventive features disclosed herein.

What is claimed is:

1. An operating system update method, comprising:
during a computer equipment power-on startup stage, controlling a system boot processor to interrupt a computer equipment startup process;
querying first system version information of a data processing unit (DPU) operating system (OS) in the computer equipment;
in response to determining that the first system version information does not match second system version information of a current host OS in the computer equipment, obtaining a system image file of the DPU OS that matches the host OS;
controlling DPU to update the DPU OS according to the system image file and restart DPU; and
controlling the system boot processor to continue the computer equipment startup process.

2. The method according to claim 1, further comprising:
during a process of installing the current host OS in the computer equipment, obtaining the second system version information of the host OS, and a system image address of the system image file of the DPU OS that matches the host OS;
downloading the system image file of the DPU OS according to the system image address;
associating the system image file with the second system version information, and storing the system image file locally or in an external device and recording an access address for accessing the system image file in the external device;
wherein the obtaining the system image file of the DPU OS that matches the host OS includes:
determining the system image file of the DPU OS stored in association with the second system version information; or
retrieving the system image file of the DPU OS from the external device according to the access address.

3. The method according to claim 1, wherein controlling DPU to update the DPU OS according to the system image file comprises:
configuring a hyper text transmission protocol (HTTP) boot service for the DPU OS and generating a system update instruction including the HTTP boot service; and
sending the system update instruction to DPU to control DPU to perform the HTTP boot service to update the DPU OS according to the system image file.

4. The method according to claim 1, further comprising:
obtaining status information of the DPU OS; and
based on the status information, determining that the DPU OS is in a running state, and performing querying the first system version information of the DPU OS in the computer equipment.

5. The method according to claim 4, after determining that the DPU OS is in the running state, further comprising:
outputting version check prompt information for the DPU OS;
obtaining a confirmation check instruction for the version check prompt information, and performing querying the first system version information of the DPU OS in the computer equipment; and
obtaining an exit check instruction for the version check prompt information, and triggering the system boot processor to continue the computer equipment startup process.

6. The method according to claim 5, wherein:
controlling the system boot processor to interrupt the computer equipment startup process comprises: sending a self-test interrupt signal to the system boot processor to trigger the system boot processor to respond to the self-test interrupt signal, and interrupting starting of a self-test process of the computer equipment; and
controlling the system boot processor to continue the computer equipment startup process comprises: sending a self-test startup signal to the system boot processor to trigger the system boot processor to respond to the self-test startup signal, and starting the self-test process of the computer equipment.

7. The method according to claim 4, further comprising:
according to the status information, determining that the DPU OS is not in the running state, and obtaining a startup duration of the DPU OS; and
determining that the startup duration is longer than a preset duration, and controlling the system boot processor to continue the computer equipment startup process.

8. The method according to claim 7, wherein:
controlling the system boot processor to interrupt the computer equipment startup process comprises: sending a self-test interrupt signal to the system boot processor to trigger the system boot processor to respond to the self-test interrupt signal, and interrupting starting of a self-test process of the computer equipment; and
controlling the system boot processor to continue the computer equipment startup process comprises: sending a self-test startup signal to the system boot processor to trigger the system boot processor to respond to the self-test startup signal, and starting the self-test process of the computer equipment.

9. The method according to claim 1, further comprising:
after determining a match between the first system version information and the second system version information, controlling the system boot processor to continue the computer equipment startup process;
after determining no match between the first system version information and the second system version information, determining whether DPU has already performed the HTTP boot service;
in response to DPU having already performed the HTTP boot service, controlling the system boot processor to continue the computer equipment startup process; and
in response to DPU having not performed the HTTP boot service, obtaining the system image file of the DPU OS that matches the host OS.

10. An operating system update apparatus comprising a memory storing a computer program and a processor couple to the memory, wherein when being executed by the processor, the computer program causes the processor to perform:
during a computer equipment power-on startup stage, controlling a system boot processor to interrupt a computer equipment startup process;
querying first system version information of a data processing unit (DPU) operating system (OS) in the computer equipment;
in response to determining that the first system version information does not match second system version information of a current host OS in the computer equipment, obtaining a system image file of the DPU OS that matches the host OS;
controlling DPU to update the DPU OS according to the system image file and restart DPU; and
controlling the system boot processor to continue the computer equipment startup process.

11. The apparatus according to claim 10, wherein the processor is further configured to perform:
during a process of installing the current host OS in the computer equipment, obtaining the second system version information of the host OS, and a system image address of the system image file of the DPU OS that matches the host OS;
downloading the system image file of the DPU OS according to the system image address;
associating the system image file with the second system version information, and storing the system image file locally or in an external device and recording an access address for accessing the system image file in the external device;
wherein the obtaining the system image file of the DPU OS that matches the host OS includes:
determining the system image file of the DPU OS stored in association with the second system version information; or
retrieving the system image file of the DPU OS from the external device according to the access address.

12. The apparatus according to claim 10, wherein the processor is further configured to perform:
configuring a hyper text transmission protocol (HTTP) boot service for the DPU OS and generating a system update instruction including the HTTP boot service; and
sending the system update instruction to DPU to control DPU to perform the HTTP boot service to update the DPU OS according to the system image file.

13. The apparatus according to claim 10, wherein the processor is further configured to perform:
obtaining status information of the DPU OS; and
based on the status information, determining that the DPU OS is in a running state, and performing querying the first system version information of the DPU OS in the computer equipment.

14. The apparatus according to claim 13, wherein after determining that the DPU OS is in the running state, the processor is further configured to perform:
outputting version check prompt information for the DPU OS;
obtaining a confirmation check instruction for the version check prompt information, and performing querying the first system version information of the DPU OS in the computer equipment; and
obtaining an exit check instruction for the version check prompt information, and triggering the system boot processor to continue the computer equipment startup process.

15. The apparatus according to claim 14, wherein:
controlling the system boot processor to interrupt the computer equipment startup process comprises: sending a self-test interrupt signal to the system boot processor to trigger the system boot processor to respond to the self-test interrupt signal, and interrupting starting of a self-test process of the computer equipment; and
controlling the system boot processor to continue the computer equipment startup process comprises: sending a self-test startup signal to the system boot processor to trigger the system boot processor to respond to the self-test startup signal, and starting the self-test process of the computer equipment.

16. The apparatus according to claim 13, wherein the processor is further configured to perform:
according to the status information, determining that the DPU OS is not in the running state, and obtaining a startup duration of the DPU OS; and
determining that the startup duration is longer than a preset duration, and controlling the system boot processor to continue the computer equipment startup process.

17. The apparatus according to claim 16, wherein:
controlling the system boot processor to interrupt the computer equipment startup process comprises: sending a self-test interrupt signal to the system boot processor to trigger the system boot processor to respond to the self-test interrupt signal, and interrupting starting of a self-test process of the computer equipment; and
controlling the system boot processor to continue the computer equipment startup process comprises: sending a self-test startup signal to the system boot processor to trigger the system boot processor to respond to the self-test startup signal, and starting the self-test process of the computer equipment.

18. The apparatus according to claim 10, wherein the processor is further configured to perform:
after determining a match between the first system version information and the second system version information, controlling the system boot processor to continue the computer equipment startup process;
after determining no match between the first system version information and the second system version information, determining whether DPU has already performed the HTTP boot service;
in response to DPU having already performed the HTTP boot service, controlling the system boot processor to continue the computer equipment startup process; and
in response to DPU having not performed the HTTP boot service, obtaining the system image file of the DPU OS that matches the host OS.

19. Computer equipment, comprising:
a host including an operating system (OS);
a data processing unit (DPU) including an OS; and
a management controller coupled to the host and the DPU respectively;
wherein the management controller is configured to perform:
during a computer equipment power-on startup stage, controlling a system boot processor to interrupt a computer equipment startup process;
querying first system version information of the DPU OS in the computer equipment;
in response to determining that the first system version information does not match second system version information of a current host OS in the computer equipment, obtaining a system image file of the DPU OS that matches the host OS;
controlling DPU to update the DPU OS according to the system image file and restart DPU; and
controlling the system boot processor to continue the computer equipment startup process.

20. The computer equipment according to claim 19, wherein the management controller is further configured to perform:
during a process of installing the current host OS in the computer equipment, obtaining the second system version information of the host OS, and a system image address of the system image file of the DPU OS that matches the host OS;
downloading the system image file of the DPU OS according to the system image address;
associating the system image file with the second system version information, and storing the system image file locally or in an external device and recording an access address for accessing the system image file in the external device;
wherein the obtaining the system image file of the DPU OS that matches the host OS includes:
determining the system image file of the DPU OS stored in association with the second system version information; or
retrieving the system image file of the DPU OS from the external device according to the access address.
